(19) United States
(12) Patent Application Publication
(10) Pub. No.: US 2010/0122953 A1
(43) Pub. Date: May 20, 2010

(54) FILTERING STRUCTURE FOR REMOVING DREGS FROM WATER

(76) Inventor: Tsung Mou YU, Taipei (TW)

Correspondence Address: Muncy, Geissler, Olds & Lowe, PLLC, P.O. BOX 1364, FAIRFAX, VA, 22038-1364, US

(21) Appl. No.: 12/482,107

(22) Filed: Jun. 10, 2009

(30) Foreign Application Priority Data
Nov. 19, 2008 (TW) 097220720

(51) Int. Cl. C02F 1/00

(52) U.S. Cl. 210/405

(57) ABSTRACT

A filtering structure for removing dregs from water is provided. The filtering structure includes a receptacle body, a dewatering unit, an operation unit, and a filtering unit. The receptacle body includes a receptacle tub and an assembling space. The dewatering unit is a hollow bucket which allows fluid flowing therethrough. The dewatering unit is assembled in the receptacle tub. The operation unit includes an operation member, a base, and a transmission mechanism connected with the operation member. The operation member is pivotally coupled to the base, and is allowed to swing like a teeterboard at a pivotal position thereof as a pivotal axis. The filtering unit includes a tank and a blade assembly. The tank is provided with a filtering screen. The blade assembly can be driven by the operation member to drive a water flow through the filtering screen, thus removing the dregs from the water.

### BACKGROUND OF THE INVENTION

1. Field of the Invention

The present invention relates generally to a filtering structure for removing dregs from water, and more particularly, to an electricity-free filtering structure adapted for removing dregs from water by applying a force on an operation unit to drive a blade assembly to rotate, thus forcing the water to flow through a filtering screen, and thereby the dregs contained in the water can be removed.

2. The Prior Arts

Mopping the floor is a routine job that has to be done everyday. In general, a cloth sheet contained with water can be used to clean the floor. More often, different types of mops are used to mop the floor. However, any cloth sheet or a mop used for cleaning the floor has to be repetitively flushed by water for removing dusts or dirt from the cloth sheet or the mop, and they have to be dewatered to a suitable water content therein for next cleaning.

The cloth sheet usually has to be dewatered by wringing with hands or by a centrifugal drier. However, a mop typically includes a mop cloth and a rod. Such a mop cannot be put inside a centrifugal drier for removing the water therefrom. Further, it is also inconvenient and laborious to wring the cloth sheet or the mop cloth. Moreover, when wringing the cloth sheet or the mop cloth with hands to remove the water, one may put his/her hands and/or skin in the risk of being hurt by the dusts, and dirt carried therein.

Current mops are often improved mainly for solving the dewatering problem. For example, an improved conventional mop is further equipped with a set of clamping rollers at the rod of the mop. The clamping rollers are adapted for squeezing out the water from the mop cloth. This improvement allows the user not to directly touch the mop cloth with hands. Further, another conventional mop wringer bucket has also been proposed for dewatering mop cloths. The mop wringer bucket employs a roller drum for squeezing and dewatering the mop cloth.

Furthermore, Taiwanese patent publication No. M338634 discloses a dewatering apparatus as shown in FIGS. 1 and 2. Referring to FIGS. 1 and 2, the dewatering apparatus is directed to provide a solution to the difficulty of dewatering the foregoing rotary type mop. The dewatering apparatus includes a receptacle body 100, a rotary unit 200, a transmission unit 300, and a driving unit 400. In operation, a cloth 501 of a rotary type mop 500 is put inside a bucket 201 of the rotary unit 200. The driving unit 400 drives the transmission unit 300, and the rotary unit 200, so as to dewatering the cloth 501 put inside the bucket 201.

Although all of the foregoing conventional mops or mop dewatering apparatus are adapted for dewatering the mop cloth, they have a common disadvantage. They neglected a critical factor of improving the cleaning performance of water or water solution. In other words, they did not provide any facility to remove the residual dregs from the water or water solution which are recycling used.

As such, it is an important concern to remove the dregs contained in water or water solution when the water or water solution are repeatedly used for cleaning the mop cloth.

### SUMMARY OF THE INVENTION

A primary objective of the present invention is to provide an electricity-free filtering structure for removing dregs from water. The filtering structure is adapted for dewatering a cloth sheet or various kinds of mop cloth. The filtering structure specifically provides a solution to remove the residual dregs from the water or the water solution which are recycling used.

For achieving the foregoing objective, the present invention provides a filtering structure for removing dregs from water. The filtering structure includes a receptacle body, a dewatering unit, an operation unit, and a filtering unit. The receptacle body includes a receptacle tub and an assembling space. The receptacle tub is adapted for receiving a water solution. The dewatering unit is assembled in the receptacle tub. The operation unit at least includes an operation member, a base and a transmission mechanism connected with the operation member. The operation member is pivotally coupled to the base, and is allowed to swing like a teeterboard at a pivotal position thereof as a pivotal axis. The filtering unit is assembled in the receptacle tub of the receptacle body. The filtering unit is configured with a water inlet, a water outlet, a filtering screen disposed at the water outlet, and a blade assembly. The blade assembly is driven by the operation unit to drive the water or the water solution received in the receptacle tub of the receptacle body to form a flow through the filtering screen, thus removing the dregs from the water or the water solution.

In operation, the user repetitively applies a force upon an operation end of the operation unit to drive a fan shaped gear rack of the operation unit. The fan shaped gear rack of the operation unit then drives an in-line gear disk, an irreversible driving gear disk, and a transmission shaft to maintain the dewatering unit in rotation or in accelerated rotation, so as to dewater the object, such as mop cloth, disposed in the dewatering unit.

The present invention provides a filtering structure for removing dregs from water. The filtering structure can be operated without an electricity power. It is operated by repetitively applying a force onto the operation unit, to directly or indirectly drive the blade assembly of the filtering unit to rotate. Therefore, the water or the water solution in the receptacle tub of the receptacle body is then guided to flow through the filtering screen, so as to remove the dregs from the water or the water solution.

The present invention provides a filtering structure for removing dregs from water. The filtering structure can be operated by repetitively applying a force onto the operation unit to maintain the dewatering unit in rotation or in accelerated rotation, so as to dewater the object disposed in the dewatering unit.

The present invention provides an electricity-free filtering structure which can be fabricated with a low cost and meet with the demands of power saving and environmental protection.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a partial exploded view of a dewatering apparatus disclosed in Taiwanese patent publication No. M338634;

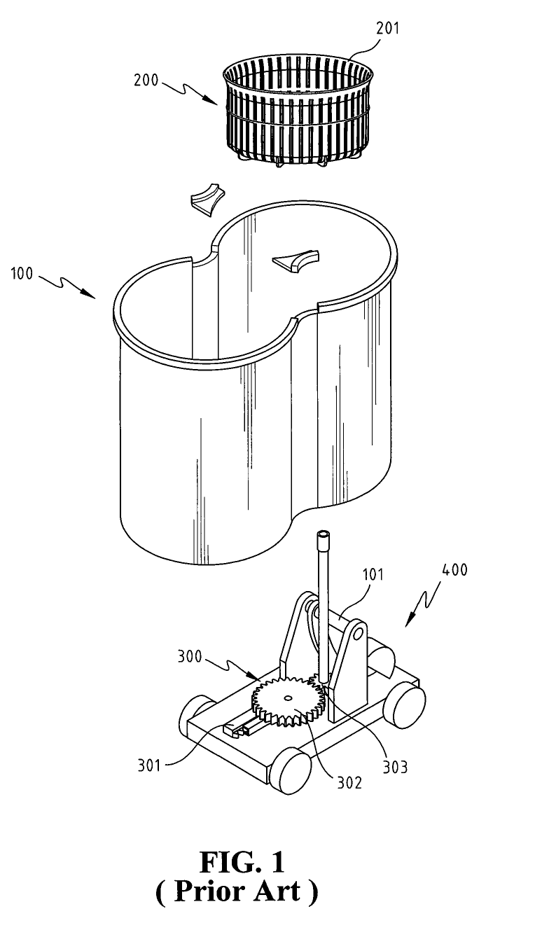

FIG. 2 is a cross-sectional view of a dewatering apparatus disclosed in Taiwanese patent publication No. M338634;

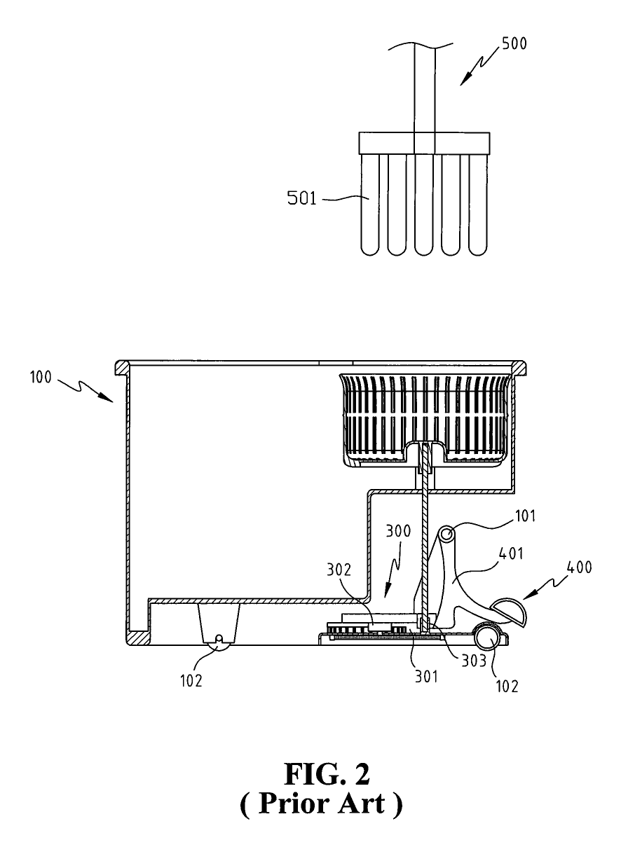

FIG. 3 is a perspective view of an embodiment of the present invention;

FIG. 4 is an exploded view of an embodiment of the present invention;

FIG. 5 is a detailed exploded view illustrating a dewatering unit and an operation unit of the embodiment of the present invention;

FIG. 6 is a schematic view illustrating the assembly of a filtering unit and the operation unit, indicating the operation of the filtering unit and a flow path of the water or water solution;

FIG. 7 is a schematic view illustrating the assembly of the dewatering unit, the operation unit, and the filtering unit according to the embodiment of the present invention;

FIG. 8 is a cross-sectional view of the assembly of the present invention;

FIG. 9 is a cross-sectional view of the embodiment of the present invention illustrating the operation of the operation unit applied by a force F; and

FIG. 10 illustrates a subsequent operation after releasing the applied force F as shown in FIG. 9.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

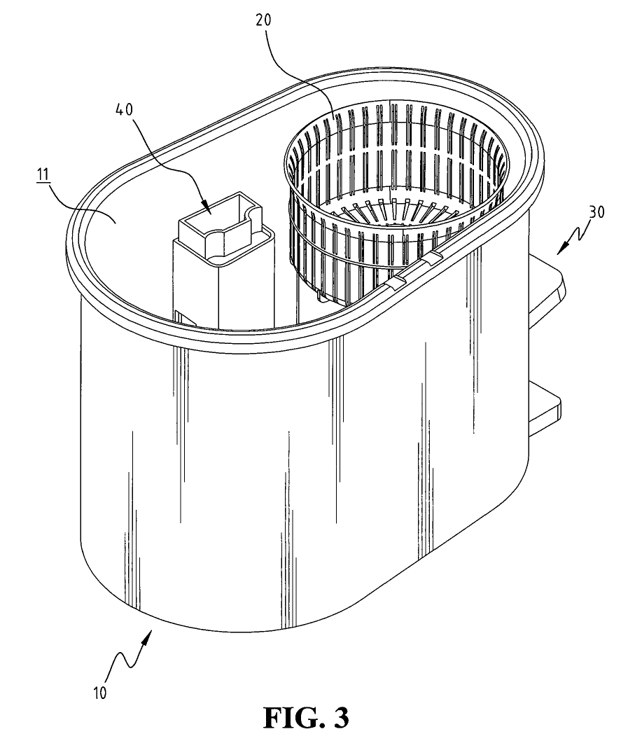

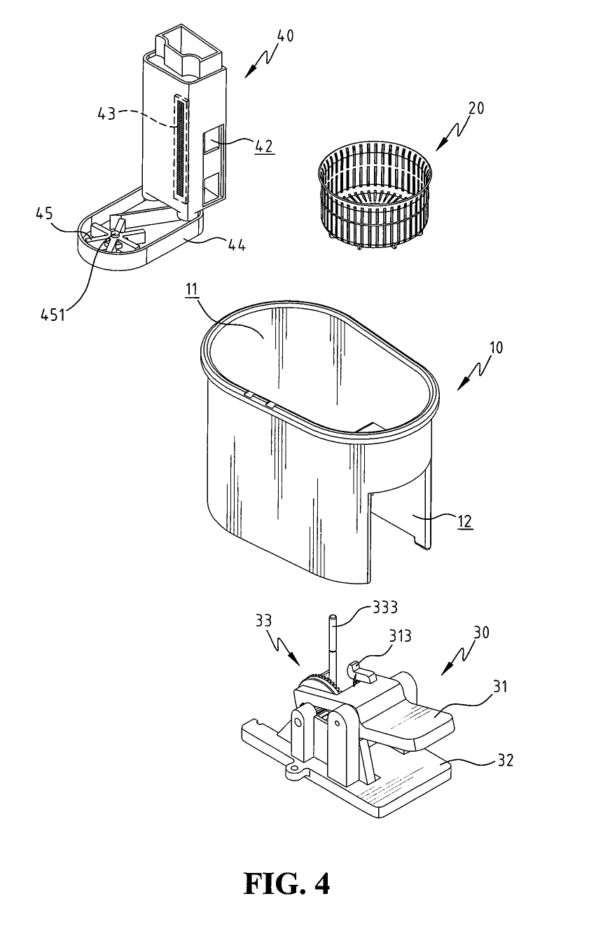

Referring to FIGS. 3, 4, 5, 6, and 7, there are shown a perspective view, an exploded view, a detailed exploded view illustrating an operation unit, and a cross-sectional view of a filtering structure according to an embodiment of the present invention.

The present invention provides a filtering structure for removing dregs from water. The filtering structure includes a receptacle body 10, a dewatering unit 20, an operation unit 30, and a filtering unit 40.

The receptacle body 10 is substantially configured to a hollow elliptical column shape, and has a receptacle tub 11 and an assembling space 12. The receptacle tub 11 and the assembling space 12 are partitioned by a water proofing material into two independent spaces. The receptacle tub 11 is adapted for receiving fluid. Typically, the fluid can be water or water solution. The assembling space 12 is defined beneath the receptacle tub 11.

The dewatering unit 20 is a hollow bucket allowing fluid flowing therethrough. The dewatering unit 20 is disposed in the receptacle tub 11.

The operation unit 30 includes an operation member 31, a base 32, and a transmission mechanism 33. The operation member 31 is adapted for providing a driving force. The base 32 is assembled with the operation member 31. The transmission mechanism 33 transmits the driving force to drive the dewatering unit 20 and the filtering unit 40 in operation.

The operation member 31 includes an operation end. The operation end is substantially configured to a treadle shape. The operation member 31 is defined with a pivotal hole 311, and is pivotally coupled to the base 32 by a pin 312. The operation member 31 is allowed to swing like a teeterboard relative to the pin 312. A hook 313 is defined at an inner side end of the operation member 31, and an elastic member 3131 is mounted between the hooks 313 and the base 32. The elastic member 3131 provides an elastic recover force to pull down the inner side end of the operation member 31 and maintain the operation end of the operation member 31 at a high position. The operation member 31 includes a hollow fan plate 314 having an inner arc surface defined with an arc gear rack 315. In this embodiment, the elastic member 3131 is preferred to be a coil spring.

The base 32 includes two supporting seats 321. Each of the two supporting seats 321 is defined with a pivotal hole 3211 corresponding to the pivotal hole 311 of the operation member 31. The pin 312 is inserted through the pivotal holes 3211 of the supporting seats 321 and the pivotal hole 311 of the operation member 31, thus pivotally fixing the operation member 31 to the base 32. In such a way, the operation member 31 is allowed to swing like a teeterboard relative to the pin 312 at the pivotal position. The base 32 is further provided with at least one supporting bracket 322 defined with a shaft hole 3221.

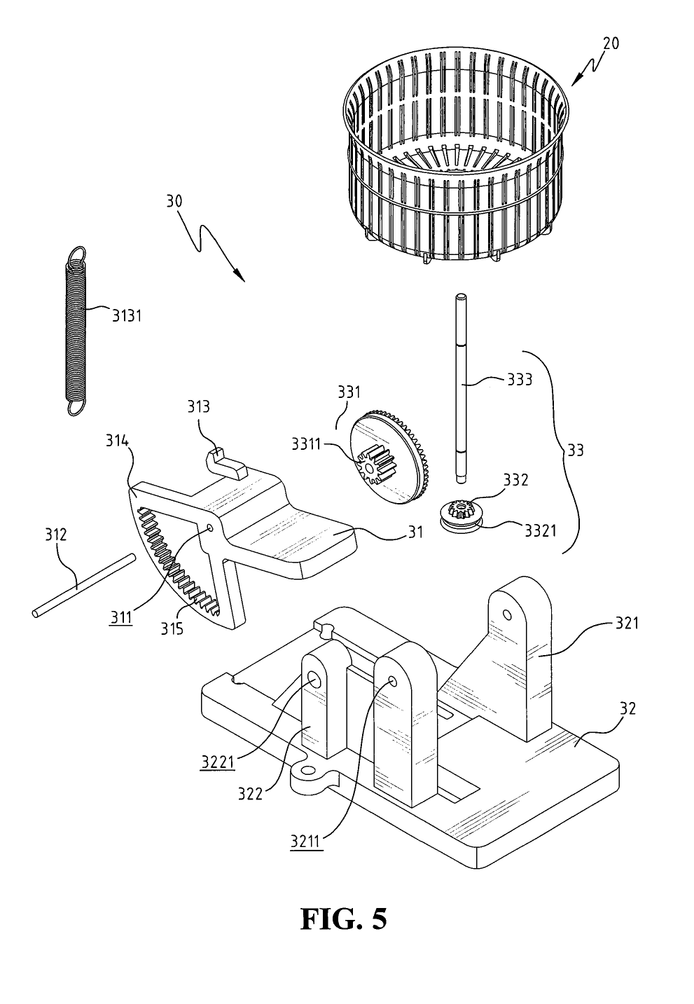

The transmission mechanism 33 includes a gear assembly and a transmission shaft 333. The gear assembly includes at least one in-line gear disk 331 and an irreversible driving gear disk 332. The irreversible driving gear disk 332 is further provided with a driving wheel 3321 which is coaxially positioned under the irreversible driving gear disk 332. The in-line gear disk 331 is pivotally coupled to the shaft hole 3221 of the supporting bracket 322. The in-line gear disk 331 includes a pinion 3311 (see FIG. 5) meshed with the arc gear rack 315 of the hollow fan plate 314. A gear disk of the in-line gear disk 331 meshes with the irreversible driving gear disk 332. In this embodiment, the in-line gear disk 331 perpendicularly meshes with the irreversible driving gear disk 332. The transmission shaft 333 is assembled to the irreversible driving gear disk 332. A lower end of the transmission shaft 333 is removably assembled to a bottom surface of the base 32. An upper end of the transmission shaft 333 passes through a bottom of the receptacle tub 11, and is further assembled with the dewatering unit 20.

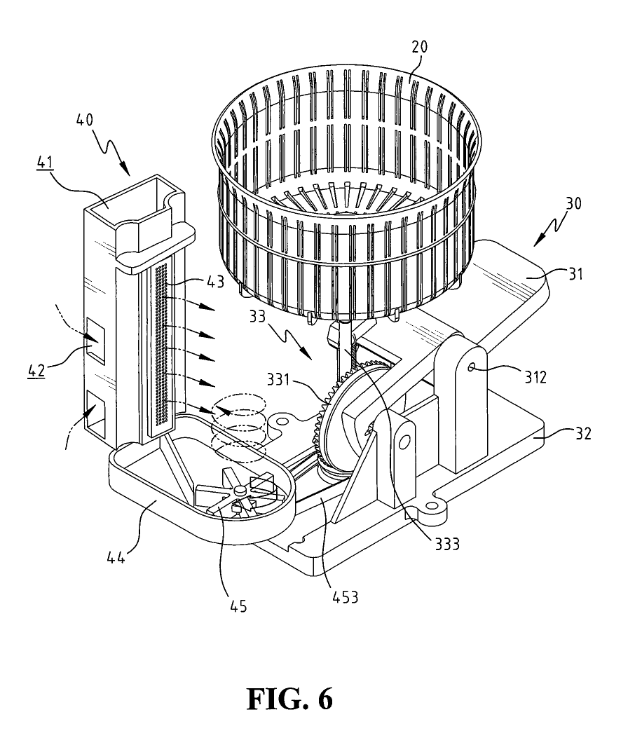

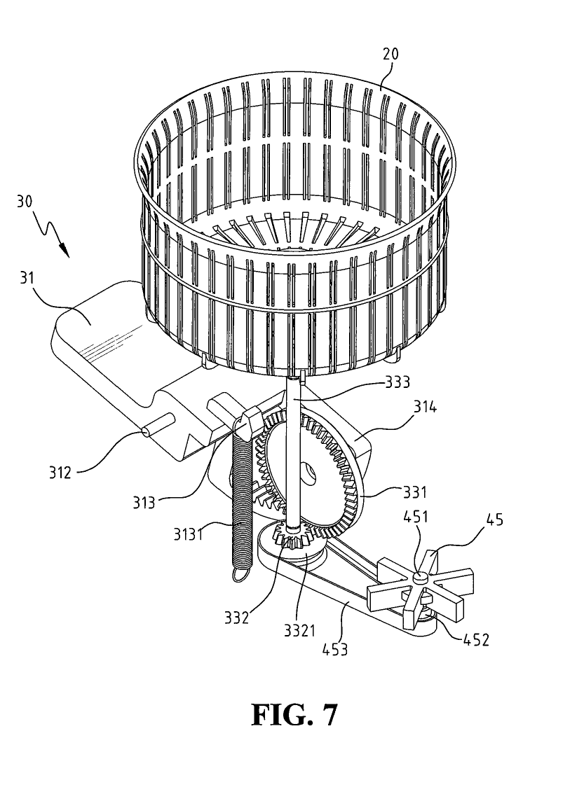

The filtering unit 40 includes a tank 41 and a bottom basin 44. The tank 41 is a hollow body and assembled in the receptacle tub 11 of the receptacle body 10. The bottom basin 44 is assembled under the tank 41 and coupled to the tank 41. The tank 41 has an opening at a top thereof. The tank 41 includes a filtering screen 43 disposed at a side facing to the bottom basin 44. A water inlet 42 is defined at another side of the tank 41, not at the side of the filtering screen 43. The filtering screen 43 also serves as a water outlet of the water or water solution in the tank 41. The bottom basin 44 is provided with a blade assembly 45 therein. The blade assembly 45 includes a shaft 451 pivotally assembled to the bottom basin 44. A lower end of the shaft 451 extends out from a bottom of the bottom basin 44 and is mounted with a driven wheel 452. The driven wheel 452 is connected to the driving wheel 3321 of the irreversible driving gear disk 332 of the operation unit 30 via a transmission belt 453, as shown in FIGS. 6 and 7.

In this embodiment, the filtering screen 43 is fixed to the filtering unit 40. Of course, in other embodiment, the filtering screen 43 can also be detachably assembled to the filtering unit 40. When the filtering screen 43 collects with dregs and/or dirt, it can be detached and cleansed, and then reassembled for next use, or even directly changed with a new one.

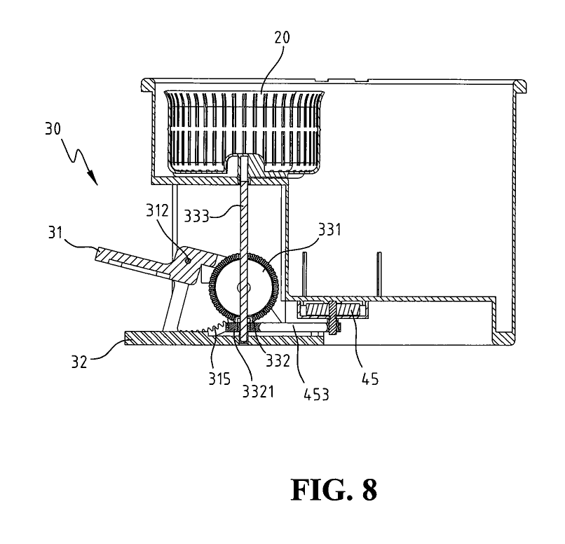

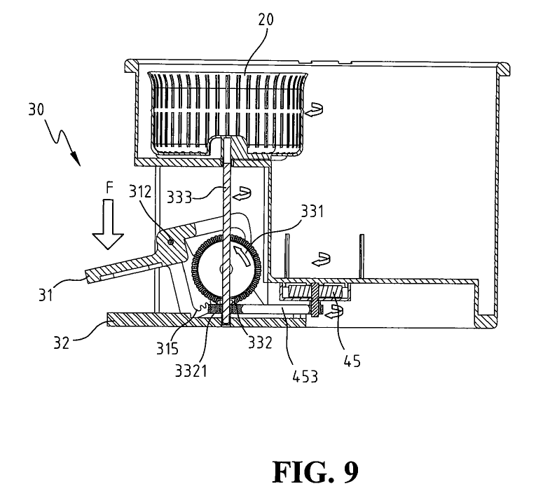

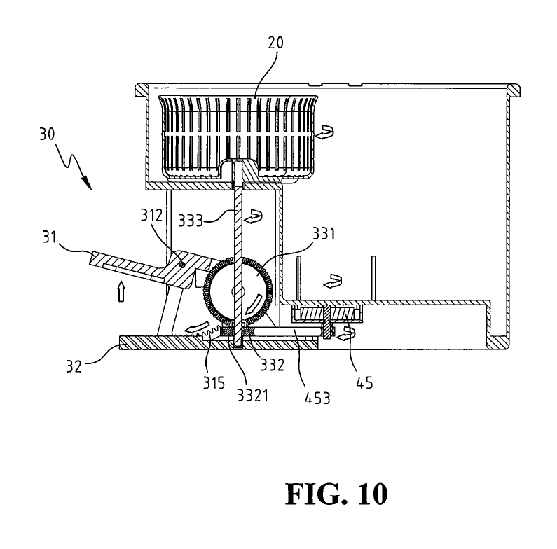

FIG. 8 is a cross-sectional view of the assembly of the present invention. FIG. 9 is a cross-sectional view of the embodiment of the present invention illustrating the operation of the operation unit 30 applied by a force F. FIG. 10 illustrates a subsequent operation after releasing the applied force F as shown in FIG. 9.

In operation, at first, the receptacle tub 11 of the receptacle body 10 is filled with water or water solution. The mop cloth is cleansed in the receptacle tub 11. The dregs, dirt or dusts are dispersed into the water or the water solution. Then the mop cloth is put in the dewatering unit 20.

When no force is applied on the operation end of the operation member 31, the inner side end of the operation member 31 is pulled down by the elastic member 3131, and therefore the operation end of the operation member 31 maintains at a high position, as shown in FIG. 8. When the user applies a force F downwardly on the operation member 31, as shown in FIG. 9, the operation end of the operation member 31 pivotally swings relative to the pin 312 and down to a low position. Meanwhile, the gear rack 315 of the operation member 31 swings upwardly to drive the pinion 3311 (see FIG. 5) and the in-line gear disk 331 to synchronously rotate in counterclockwise direction. The in-line gear disk 331 drives the irreversible driving gear disk 332, the transmission shaft 333 and the dewatering unit 20 to rotate in clockwise direction. The driving wheel 3321 of the irreversible driving gear disk 332 drives the transmission belt 453 to drive the driven wheel 452 and the blade assembly 45 to synchronously rotate in clockwise direction. The blade assembly 45 rotates thus to carry the water or the water solution in the bottom basin 44 to form a vortex. The vortex produces a relative low hydraulic pressure, thus drawing the water or the water solution in the tank 41 to flow through the filtering screen (water outlet) 43. Further, referring to FIG. 6, the hydraulic pressure in the tank 41 decreases, so that the water or the water solution in the receptacle tub 11 flows into the tank 41 via the water inlet 42 and then flows through the filtering screen 43 to form a water flow. When the water or the water solution flows through the filtering screen 43, the dregs contained therein will be filtered and removed. In such a way, the dregs can be removed from the water or the water solution to achieve the purpose of purifying the water or the water solution. Meanwhile, the operation end of the operation member 31 moves downwardly, whereas the hook 313 moves upwardly. Accordingly the elastic member 3131 is stretched out to accumulate an elastic recovery force. When the force F applied on the operation member 31 is released, the operation end of the operation member 31 swings to the high position under the action of the elastic recovery force on the inner side end of the operation member 31, as shown in FIG. 10. While the operation end of the operation member 31 swings upwardly, the gear rack 315 swings downwardly to drive the pinion 3311 together with the in-line gear disk 331 to synchronously rotate in clockwise direction. Meanwhile, the pinion 3311 together with the in-line gear disk 331 drive the irreversible driving gear disk 332 to rotate in counterclockwise direction. However, the irreversible driving gear disk 332 can only drive the transmission shaft 333 to rotate toward one fixed direction, e.g., clockwise direction in this embodiment, and therefore, the transmission shaft 333 and the dewatering unit 20 remains to be rotating in clockwise direction.

The user can alternatively and repetitively apply and release a force F on the operation end of the operation member 31 of the present invention, so that the arc gear rack 315 of the operation unit 30 drives the in-line gear disk 331, the irreversible driving gear disk 332, the transmission shaft 333, and the driving wheel 3321, and thus drive the dewatering unit 20 and the blade assembly 45 to be kept in rotation or accelerated rotation in clockwise direction. In such a way, the mop cloth contained with the water can be dewatered in the dewatering unit 20, and the dregs can be removed from the water or the water solution by the filtering unit 40.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A filtering structure for removing dregs from water, comprising:
a receptacle body, comprising a receptacle tub and an assembling space, wherein the receptacle tub and the assembling space are partitioned by a water proofing material into two independent spaces;
an operation unit, comprising an operation member, a base and a transmission mechanism, wherein the operation member is connected to the transmission mechanism and is pivotally coupled to the base; and
a filtering unit, comprising a tank and a bottom basin, wherein the tank is assembled in the receptacle tub of the receptacle body, the tank is provided with a filtering screen and is configured with at least one water inlet, and the filtering screen serves as a water outlet, the bottom basin is connected to the tank at a bottom side of the tank, a blade assembly is received inside the bottom basin, the blade assembly comprises a shaft disposed at the bottom basin, and the shaft and the transmission mechanism of the operation unit are driven in linkage with each other, wherein the operation member provides a driving force and the transmission mechanism transmits the driving force to drive the blade assembly and then the filtering unit in operation.

2. The filtering structure for removing dregs from water according to claim 1, wherein
the operation member of the operation unit is allowed to swing like a teeterboard at a pivotal position thereof as a pivotal axis, an elastic member is assembled between the operation member and the base, the elastic member provides an elastic force to lift the operation member to a high position, the operation member is connected to a gear rack;
the transmission mechanism of the operation unit comprises a gear assembly and a transmission shaft, wherein the gear assembly comprises at least one in-line gear disk and an irreversible driving gear disk, the in-line gear disk meshes with the gear rack of the operation member, and the in-line gear disk also meshes with the irreversible driving gear disk, the irreversible driving gear disk is provided with a driving wheel positioned under and coaxial with the irreversible driving gear disk, the transmission shaft is assembled to the irreversible driving gear disk, and the transmission shaft is pivotally connected to the base; and
the blade assembly of the filtering unit is further provided with a driven wheel at a lower end of the shaft of the blade assembly, and the driven wheel is connected to the driving wheel of the irreversible driving gear disk by a transmission belt.

3. The filtering structure for removing dregs from water according to claim 2, wherein the elastic member of the operation member is a coil spring.

4. The filtering structure for removing dregs from water according to claim 1, wherein the filtering screen is detachably assembled to the filtering unit.

5. A filtering structure for removing dregs from water, comprising:
a receptacle body, comprising a receptacle tub and an assembling space, wherein the receptacle tub and the assembling space are partitioned by a water proofing material into two independent spaces;
a dewatering unit, being a hollow bucket allowing fluid flowing therethrough and disposed in the receptacle tub;
an operation unit, comprising an operation member and a transmission mechanism, wherein the operation member is connected to the transmission mechanism and is pivotally coupled to the base, the dewatering unit and the operation unit are driven in linkage with each other; and
a filtering unit, comprising a tank and a bottom basin, wherein the tank is assembled in the receptacle tub of the receptacle body, the tank is provided with a filtering screen, and is configured with at least one water inlet, and the filtering screen serves as a water outlet, the bottom basin is connected to the tank at a bottom side of the tank, a blade assembly is received inside the bottom basin, the blade assembly comprises a shaft disposed at the bottom basin, and the shaft and the transmission mechanism of the operation unit are driven in linkage with each other,
wherein the operation member provides a driving force and the transmission mechanism transmits the driving force to drive the dewatering unit and the blade assembly and then the filtering unit in operation.

6. The filtering structure for removing dregs from water according to claim 5, wherein
the operation member of the operation unit is allowed to swing like a teeterboard at a pivotal position thereof as a pivotal axis, an elastic member is assembled between the operation member and the base, the elastic member provides an elastic force to lift the operation member to a high position, the operation member is connected to a gear rack;
the transmission mechanism of the operation unit comprises a gear assembly and a transmission shaft, wherein the gear assembly comprises at least one in-line gear disk and an irreversible driving gear disk, the in-line gear disk meshes with the gear rack of the operation member, and the in-line gear disk also meshes with the irreversible driving gear disk, the irreversible driving gear disk is provided with a driving wheel positioned under and coaxial with the irreversible driving gear disk, the transmission shaft is assembled to the irreversible driving gear disk, the transmission shaft is pivotally connected to the base, and an upper end of the transmission shaft extends through a bottom surface of the receptacle tub and is assembled with the dewatering unit.

7. The filtering structure for removing dregs from water according to claim 6, wherein the elastic member of the operation member is a coil spring.

8. The filtering structure for removing dregs from water according to claim 5, wherein the filtering screen is detachably assembled to the filtering unit.
